(19) United States
(12) Patent Application Publication
(10) Pub. No.: US 2026/0111314 A1
(43) Pub. Date: Apr. 23, 2026

(54) PRIORITIZED STORAGE ARRAY REBUILD

(71) Applicant: Dell Products L.P., Round Rock, TX (US)

(72) Inventors: Ramesh Doddaiah, Westborough, MA (US); Lixin Pang, Needham, MA (US); Rong Yu, West Roxbury, MA (US); Shao Hu, Westborough, MA (US)

(73) Assignee: Dell Products L.P., Round Rock, TX (US)

(21) Appl. No.: 18/918,216

(22) Filed: Oct. 17, 2024

(51) Int. Cl. G06F 11/10; G06F 11/34

(52) U.S. Cl. CPC G06F 11/1092; G06F 11/34

(57) ABSTRACT

One or more aspects of the present disclosure relate to optimizing the rebuild process of a persistent storage device in a storage array is disclosed. The embodiments detect rebuild events, identify affected back-end slices, and prioritize the rebuild order based on a calculated priority score for each slice. This score is derived from service level objectives (SLO) and input/output (IO) statistics of corresponding front-end logical tracks. The embodiments can generate SLO slice objects representing back-end slices, group them in a shared memory database, and update scores during write operations. Rebuild job queues with different priority levels are established, and back-end slices are queued based on their priority scores. This approach ensures efficient rebuilding of critical data, considering both SLOs and real-time IO statistics, thus minimizing performance degradation and enhancing overall system reliability.

### BACKGROUND

Storage arrays are complex systems designed to manage and store large volumes of data across multiple disk drives. These arrays employ redundancy techniques, such as RAID (Redundant Array of Independent Disks), to ensure data availability and protect against drive failures. In modern storage environments, arrays often contain many disk drives, subject to various factors that may compromise data integrity or performance. These factors include aging, wear and tear, media errors, firmware issues, environmental stress, and overutilization. To maintain data reliability and system performance, storage arrays implement mechanisms to detect and address potential issues, including background processes that continuously monitor and maintain the health of the storage system.

### SUMMARY

One or more aspects of the present disclosure relate to prioritizing rebuilding a storage device. In embodiments, an event requiring a rebuild of a persistent storage device of a storage array is detected. Additionally, each back-end slice associated with the persistent storage device is identified. Further, the persistent storage device is rebuilt in an order corresponding to a priority rebuild score of each back-end slice associated with the persistent storage device.

In embodiments, each front-end logical track corresponding to each back-end slice associated with the persistent storage device can be identified.

In embodiments, one or more input/output (IO) workloads received by the storage array can be monitored. IO statistics corresponding to each IO operation targeting each front-end logical track can also be collected.

In embodiments, a service level objective (SLO) corresponding to each front-end logical can be determined.

In embodiments, a priority score for each back-end slice can be calculated based on the IO statistics and the SLO of each front-end logical track corresponding to each back-end slice.

In embodiments, an SLO slice object can be generated to represent each back-end slice. Further, each SLO slice object can include n-bits representing its corresponding priority rebuild score. Additionally, SLO slice objects can be grouped in an SLO database stored in a shared memory of the storage array.

In embodiments, the priority score for each back-end slice can be updated during one or more Local Synchronous Write Destage (LSWD) processes.

In embodiments, at least one rebuild job queue, including a corresponding rebuild priority level, can be established.

In embodiments, each back-end slice requiring a rebuild in the at least one rebuild job queue can be queued based on the priority rebuild score of each back-end slice and the rebuild priority level of the at least one rebuild job queue.

In embodiments, the persistent storage device can be rebuilt in an order defined by a position of each back-end slice in the at least one rebuild job queue.

Other technical features may be readily apparent to one skilled in the art from the following figures, descriptions, and claims.

### BRIEF DESCRIPTION OF THE DRAWINGS

The preceding and other objects, features, and advantages will be apparent from the following more particular description of the embodiments, as illustrated in the accompanying drawings. Like reference, characters refer to the same parts throughout the different views. The drawings are not necessarily to scale, emphasis instead being placed upon illustrating the embodiments' principles.

FIG. 1 illustrates a distributed network environment in accordance with embodiments of the present disclosure.

FIG. 2 is a cross-sectional view of a storage device in accordance with embodiments of the present disclosure.

FIG. 3 is a block diagram of a redundant array of independent disks (RAID) in accordance with embodiments of the present disclosure FIG. 4 is a block diagram of the processing of an input/output (IO) workload by a storage array in accordance with embodiments of the present disclosure

FIG. 5 is a block diagram of the rebuilding of a storage device in accordance with embodiments of the present disclosure

FIG. 6 is a flow diagram of a method for prioritizing rebuilding a storage device per embodiments of the present disclosure.

### DETAILED DESCRIPTION

In today's digital age, data storage and management have become critical components of modern businesses and organizations. Storage arrays, which consist of multiple disk drives working together to provide large-scale data storage solutions, play a vital role in maintaining the integrity and availability of crucial information. However, like any physical device, disk drives within these storage arrays are susceptible to various issues that can compromise data integrity and system performance.

Currently, storage array technology involves using a redundant array of independent disk (RAID) configurations to protect against data loss due to disk failures. When a disk drive fails or experiences errors, a process called “rebuild” is initiated to reconstruct the data on a new or repaired drive. This rebuild process is essential for maintaining data redundancy and ensuring system reliability.

However, the existing approach to storage array rebuilds faces several challenges. Traditionally, background rebuilds are executed sequentially based on the back-end device number sequence without considering the criticality or performance requirements of the data stored on different drives. This means that the time taken to reach and rebuild a problematic drive depends solely on its device number and track number rather than the importance of the data it contains or its service level objectives (SLOs).

The problem with this approach is twofold. First, the rebuild process can be highly time-consuming in large storage arrays with numerous drives. This extended duration increases the risk of data loss if additional drive failures occur before the rebuild is complete. Second, the lack of prioritization in the rebuild process means critical data or high-performance applications may experience prolonged degraded performance or increased vulnerability.

To address these challenges, embodiments of the present disclosure optimize the storage array rebuild process using Service Level Objectives (SLOs) and Input/Output (IO) statistics. This innovative approach aims to prioritize rebuilding drives containing the most critical data and those most likely to impact system performance.

The embodiments of the present disclosure introduce sophisticated techniques for calculating priority scores for each back-end slice (a portion of the storage array) based on the SLOs associated with the data stored on it and the IO statistics gathered from real-time system monitoring. These priority scores are then used to determine the order in which different parts of the storage array are rebuilt. For example, the embodiments can include a database that stores SLO Slice objects, representing each back-end slice and its associated priority score.

The embodiments can calculate priority scores based on SLO categories and IO statistics for each thin device track (a logical unit of storage). Further, the embodiments can update priority scores during write operations, ensuring the rebuild prioritization remains current and accurate. Using the priority scores, the embodiments can establish rebuild job queues with different priority levels, allowing for efficient scheduling of rebuild tasks.

The embodiments can advantageously enable storage arrays to recover more effectively from disk errors, prioritizing reconstructing mission-critical data and minimizing the impact on system performance. This approach offers an end-to-end solution for customers utilizing Quality of Service (QoS) requirements, ensuring their expected service quality level is maintained even during rebuild operations.

Thus, while current storage array rebuild processes face challenges regarding efficiency and prioritization, the embodiments disclosed herein leverage SLOs and IO statistics to optimize the rebuild process. This innovation enhances data protection, improves system performance during rebuilds, and provides a more responsive and intelligent approach to managing storage array failures.

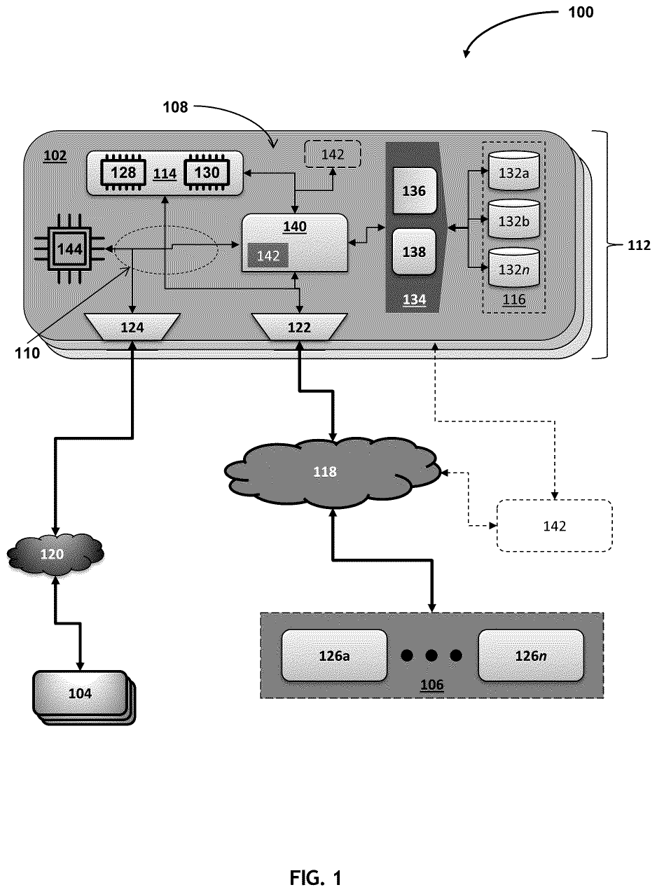

Regarding FIG. 1, a distributed network environment 100 can include a storage array 102, a remote system 104, and hosts 106. In embodiments, the storage array 102 can include components 108 that perform one or more distributed file storage services. In addition, the storage array 102 can include one or more internal communication channels 110 like Fibre channels, busses, and communication modules that communicatively couple the components 108. Further, the distributed network environment 100 can define an array cluster 112, including the storage array 102 and one or more other storage arrays.

In embodiments, the storage array 102, components 108, and remote system 104 can include a variety of proprietary or commercially available single or multi-processor systems (e.g., parallel processor systems). Single or multi-processor systems can include central processing units (CPUs), graphical processing units (GPUs), and others. Additionally, the storage array 102, remote system 104, and hosts 106 can virtualize one or more of their respective physical computing resources (e.g., processors (not shown), memory 114, and persistent storage 116).

In embodiments, the storage array 102 and, e.g., one or more hosts 106 (e.g., networked devices) can establish a network 118. Similarly, the storage array 102 and a remote system 104 can establish a remote network 120. Further, the network 118 or the remote network 120 can have a network architecture that enables networked devices to send/receive electronic communications using a communications protocol. For example, the network architecture can define a storage area network (SAN), local area network (LAN), wide area network (WAN) (e.g., the Internet), an Explicit Congestion Notification (ECN), Enabled Ethernet network, and the like. Additionally, the communications protocol can include a Remote Direct Memory Access (RDMA), TCP, IP, TCP/IP protocol, SCSI, Fibre Channel, Remote Direct Memory Access (RDMA) over Converged Ethernet (ROCE) protocol, Internet Small Computer Systems Interface (iSCSI) protocol, NVMe-over-fabrics protocol (e.g., NVMe-over-ROCEv2 and NVMe-over-TCP), and the like.

Further, the storage array 102 can connect to the network 118 or remote network 120 using one or more network interfaces. The network interface can include a wired/wireless connection interface, bus, data link, and the like. For example, a host adapter (HA 122), e.g., a Fibre Channel Adapter (FA) and the like, can connect the storage array 102 to the network 118 (e.g., SAN). Further, the HA 122 can receive and direct IOs to one or more of the storage array's components 108, as described in greater detail herein.

Likewise, a remote adapter (RA 124) can connect the storage array 102 to the remote network 120. Further, the network 118 and remote network 120 can include communication mediums and nodes that link the networked devices. For example, communication mediums can include cables, telephone lines, radio waves, satellites, infrared light beams, etc. The communication nodes can also include switching equipment, phone lines, repeaters, multiplexers, and satellites. Further, the network 118 or remote network 120 can include a network bridge that enables cross-network communications between, e.g., the network 118 and remote network 120.

In embodiments, hosts 106 connected to the network 118 can include client machines 126a-n, running one or more applications. The applications can require one or more of the storage array's services. Accordingly, each application can send one or more input/output (IO) messages (e.g., a read/write request or other storage service-related request) to the storage array 102 over the network 118. Further, the IO messages can include metadata defining performance requirements according to a service level agreement (SLA) between hosts 106 and the storage array provider.

In embodiments, the storage array 102 can include a memory 114, such as volatile or nonvolatile memory. Further, volatile and nonvolatile memory can include random access memory (RAM), dynamic RAM (DRAM), static RAM (SRAM), and the like. Moreover, each memory type can have distinct performance characteristics (e.g., speed corresponding to reading/writing data). For instance, the types of memory can include register, shared, constant, user-defined, and the like. Furthermore, in embodiments, the memory 114 can include global memory (GM 128) that can cache IO messages and their respective data payloads. Additionally, the memory 114 can include local memory (LM 130) that stores instructions that the storage array's processors 144 can execute to perform one or more storage-related services. For example, the storage array 102 can have a multi-processor architecture that includes one or more CPUs (central processing units) and GPUs (graphical processing units).

In addition, the storage array 102 can deliver its distributed storage services using persistent storage 116. For example, the persistent storage 116 can include multiple thin-data devices (TDATs) such as persistent storage drives 132a-n. Further, each TDAT can have distinct performance capabilities (e.g., read/write speeds) like hard disk drives (HDDs) and solid-state drives (SSDs).

Further, the HA 122 can direct one or more IOs to an array component 108 based on their respective request types and metadata. In embodiments, the storage array 102 can include a device interface (DI 134) that manages access to the array's persistent storage 116. For example, the DI 134 can include a disk adapter (DA 136) (e.g., storage device controller), flash drive interface 138, and the like that control access to the array's persistent storage 116 (e.g., storage devices 132a-n).

Likewise, the storage array 102 can include an Enginuity Data Services processor (EDS 140) that can manage access to the array's memory 114. Further, the EDS 140 can perform one or more memory and storage self-optimizing operations (e.g., one or more machine learning techniques) that enable fast data access. Specifically, the operations can implement techniques that deliver performance, resource availability, data integrity services, and the like based on the SLA and the performance characteristics (e.g., read/write times) of the array's memory 114 and persistent storage 116. For example, the EDS 140 can deliver hosts 106 (e.g., client machines 126a-n) remote/distributed storage services by virtualizing the storage array's memory/storage resources (memory 114 and persistent storage 116, respectively).

In embodiments, the storage array 102 can also include a controller 142 (e.g., management system controller) that can reside externally from or within the storage array 102 and one or more of its components 108. When external from the storage array 102, the controller 142 can communicate with the storage array 102 using any known communication connections. For example, the communications connections can include a serial port, parallel port, network interface card (e.g., Ethernet), etc. Further, the controller 142 can include logic/circuitry that performs one or more storage-related services. For example, the controller 142 can have an architecture designed to manage the storage array's computing, processing, storage, and memory resources as described in greater detail herein.

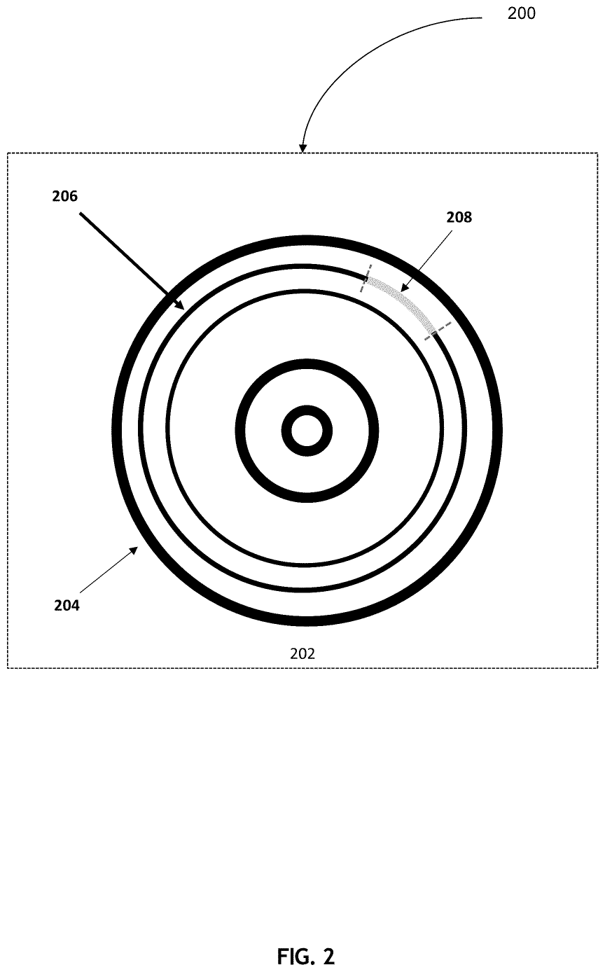

Regarding FIG. 2, the storage array's EDS 140 can virtualize the array's persistent storage 116. Specifically, the EDS 140 can virtualize a storage device 200, which is substantially like one or more of the storage devices 132a-n. For example, the EDS 140 can provide a host, e.g., client machine 126a, with a virtual storage device (e.g., thin-device (TDEV)) that logically represents zero or more portions of each storage device 132a-n. For example, the EDS 140 can establish a logical track using zero or more physical address spaces from each storage device 132a-n. Specifically, the EDS 140 can establish a continuous set of logical block addresses (LBA) using physical address spaces from the storage devices 132a-n. Thus, each (LBA) represents a corresponding physical address space from one of the storage devices 132a-n. For example, a track can include 256 LBAs, amounting to 128 KB of physical storage space. Further, the EDS 140 can establish the TDEV using several tracks based on the desired storage capacity of the TDEV. The EDS 140 can also establish extents that logically define a group of tracks.

In embodiments, the EDS 140 can provide each TDEV with a unique identifier (ID) like a target ID (TID). Additionally, EDS 140 can establish a logical unit number (LUN) that maps each track of a TDEV to its corresponding physical track location using pointers. Further, the EDS 140 can also generate a searchable data structure, mapping logical storage representations to their corresponding physical address spaces. Thus, EDS 100 can enable the HA 122 to present the hosts 106 with the logical storage representations based on host or application performance requirements.

For example, the persistent storage 116 can include an HDD 202 with stacks of cylinders 204. Like a vinyl record's grooves, each cylinder 204 can include one or more tracks 206. Each track 206 can include continuous sets of physical address spaces representing each of its sectors 208 (e.g., slices or portions thereof). The EDS 140 can provide each slice/portion with a corresponding logical block address (LBA). The EDS 140 can also group sets of continuous LBAs to establish one or more tracks. Further, the EDS 140 can group a set of tracks to establish each extent of a virtual storage device (e.g., TDEV). Thus, each TDEV can include tracks and LBAs corresponding to one or more of the persistent storage 116 or portions thereof (e.g., tracks and address spaces).

As stated herein, the persistent storage 116 can have distinct performance capabilities. For example, an HDD architecture is known by skilled artisans to be slower than an SSD's architecture. Likewise, the array's memory 114 can include different memory types, each with distinct performance characteristics described herein. In embodiments, the EDS 140 can establish a storage or memory hierarchy based on the SLA and the performance characteristics of the array's memory/storage resources. For example, the SLA can include one or more Service Level Objectives (SLOs) specifying performance metric ranges (e.g., response times and uptimes) corresponding to the hosts' performance requirements.

Further, the SLO can specify service level (SL) tiers corresponding to each performance metric range and categories of data importance (e.g., critical, high, medium, low). For example, the SLA can map critical data types to an SL tier requiring the fastest response time. Thus, the storage array 102 can allocate the array's memory/storage resources based on an IO workload's anticipated volume of IO messages associated with each SL tier and the memory hierarchy.

For example, the EDS 140 can establish the hierarchy to include one or more tiers (e.g., subsets of the array's storage and memory) with similar performance capabilities (e.g., response times and uptimes). Thus, the EDS 140 can establish fast memory and storage tiers to service host-identified critical and valuable data (e.g., Platinum, Diamond, and Gold SLs). In contrast, slow memory and storage tiers can service host-identified, non-critical, less valuable data (e.g., Silver and Bronze SLs). The EDS 140 can also define “fast” and “slow” performance metrics based on relative performance measurements of the array's memory 114 and persistent storage 116. Thus, the fast tiers can include memory 114 and persistent storage 116, with relative performance capabilities exceeding a first threshold. In contrast, slower tiers can include memory 114 and persistent storage 116, with relative performance capabilities falling below a second threshold. Further, the first and second thresholds can correspond to the same threshold.

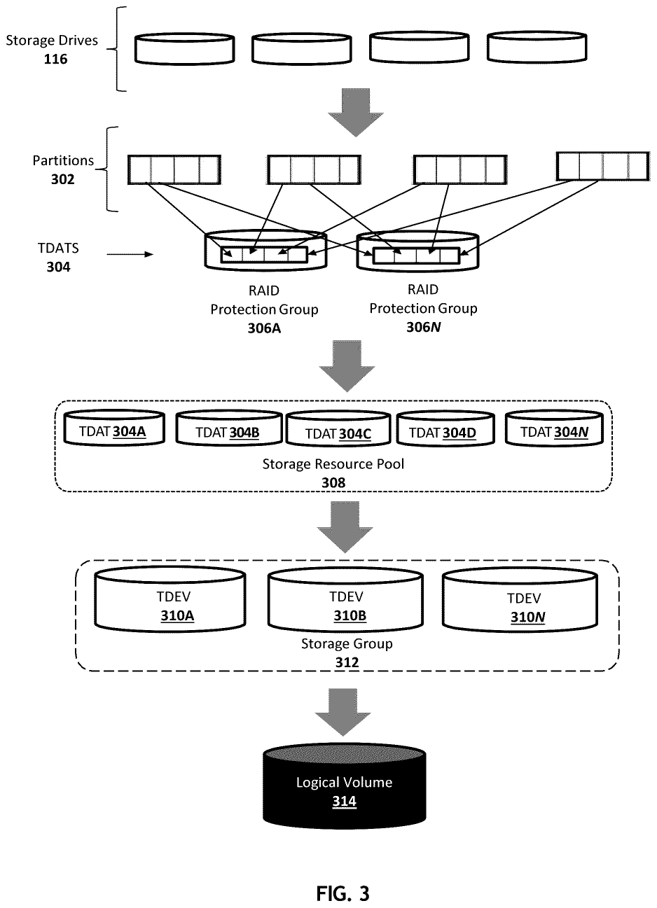

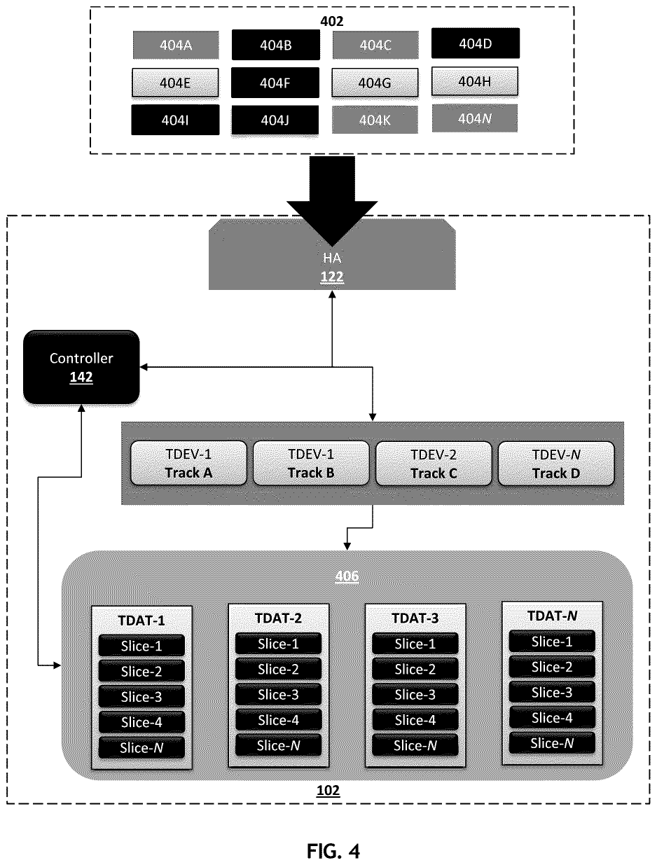

Regarding FIG. 3, the controller 142 of FIG. 1 can manage one or more persistent storage drives 116 of a storage array (e.g., the storage array 102 of FIG. 1). In embodiments, the controller 142 can generate an abstraction between the drives 116 and a logical volume 314. The controller 142 can characterize the drives 116 by different sector unit sizes (e.g., 2 KB). Additionally, the controller 142 can process sector unit sizes of each drive 116 to generate the abstraction.

In embodiments, the controller 142 can organize the drives 116 into logical partitions 302 (e.g., splits) of equal storage capacity. In embodiments, a selection of split storage capacity can be a design implementation and, for context and without limitation, may be some fraction or percentage of the capacity of a managed drive equal to an integer multiple of sectors greater than 1. Each split can include a contiguous range of logical addresses. For example, the controller 142 can group the splits 302 from one or more of the drives 116 to create data devices (TDATs) 304.

The controller 142 can further organize each TDAT's splits 302 as protection group members, e.g., RAID protection groups (or slices) 306A-N. A storage resource pool 308, also known as a “data pool” or “thin pool,” is a collection of TDATs 304A-N of an emulation and RAID protection type, e.g., RAID-5. In some implementations, all TDATs 304A-N in a drive group are of a single RAID protection type and are the same size (e.g., have equal storage capacity).

In embodiments, the controller 142 can establish logical thin devices (TDEVs) 310A-N using the TDATs 304A-N. The TDATs 304A-N and TDEVs 310A-N are accessed using tracks as the allocation unit. The controller 142 can also organize one or more TDEVs 312A-N into a storage group 312. Further, the controller 142 can establish a logical volume 314 from the storage group 312. Additionally, host application data can be stored in data blocks on the logical volume 314. Further, the controller 142 can map the host application data to tracks of the TDEVs 310A-N. The controller 142 can also map the TDEVs 310A-N to sectors or corresponding tracks of the drives 116. For example, the controller 142 can map tracks of the TDEVs 310A-N to corresponding RAID slices 306A-N of the TDATs 304.

In embodiments, the controller 142 can create RAID slices (or protection groups) 306A-N from physical storage devices 116 through logical portioning and grouping. For example, the controller 142 can divide the physical storage devices 116 into smaller units called tracks, with each back-end track being 128KB in size. The controller 142 can then logically group the tracks into slices, which form the basis of a RAID configuration.

Depending on the RAID type configuration, a RAID slice can include multiple data members plus one or two parity members. For example, a “4+1” RAID configuration includes 4 data members and 1 parity member. The controller 142 can distribute the members across different physical storage devices 116 to provide redundancy and improve performance.

The controller 142 can manage the logical representations of the physical disk partitions using the device number. For instance, the controller 142 can divide a physical storage device (e.g., drive 132a of FIG. 1) into many tracks, and each track can be assigned to different logical devices. Thus, a single physical drive can contain portions of multiple logical devices; conversely, a single logical device can span multiple physical drives.

When a physical drive fails or needs replacement, the controller 142 can identify all the logical devices and slices affected by that drive's failure. The controller 142 can then rebuild the data for each affected slice, using the remaining data members and parity information to recreate the lost data. While the controller 142 creates the RAID slices 306A-N from the physical storage devices 116, the controller 142 manages them as logical entities. This abstraction allows for more flexible management and optimization of the storage array, including prioritizing rebuilds based on service level objectives (SLOs) and IO statistics.

Regarding FIG. 4, a storage array 102 can receive an IO workload 402, including one or more IO operations 404A-N. In embodiments, a host adapter (HA) 122 can process and analyze the IO workload 402 and its IO operations 404A-N. The HA 122 can identify characteristics of each IO operation 404A-N, including IO type (e.g., read or write request), IO size, frequency, patterns, service level objective (SLO), thin device (TDEV) track association, and the like.

In embodiments, TDEVs (e.g., TDEVs1-N) are logical storage units representing front-end tracks (e.g., Tracks A-D). Each TDEV track can correspond to a portion of a back end (BE) slice. Each BE slice represents portions (e.g., Slices 1-N) of physical storage on persistent storage (e.g., TDATs 1-N) of the storage array 102.

Accordingly, each BE slice can correspond to one or more front-end TDEV tracks.

In embodiments, the controller 142 can trigger a Local Synchronous Write Destage (LSWD) process for each IO operation, including a write request. Specifically, when a write request is received, it is first written to a local cache (e.g., GM 128 of FIG. 1). The LSWD process ensures that data written to the local cache is synchronously written (or “destaged”) from the cache to persistent storage (e.g., TDATs 1-N).

In embodiments, the controller 142 can (e.g., during the LSWD process) collect information corresponding to each IO operation 404A-N and their corresponding TDEV tracks (e.g., Tracks A-D). For example, the controller 142 can collect IO statistics for each front-end track (e.g., Tracks A-D). The IO statistics can include read and write IO activities for each front-end track (e.g., Tracks A-D), IO size, IO frequency, IO burst patterns, IO trends, IO rate, and the like. The controller 142 can also collect SLO information corresponding to each IO operation 404A-N and their target TDEV tracks (Tracks A-N). The SLO information can correspond to a service level such as Diamond, Silver, Bronze, and the like, representing different data priority levels.

Further, the controller 142 can map TDEV tracks (Tracks A-D) to their corresponding back-end slices (e.g., one of Slices 1-N of TDATS 1-N). For example, the controller 142 can maintain a mapping table that maps front-end tracks to back-end tracks. Accordingly, the controller 142 can use the mapping table to map each IO operation's target TDEV track to its corresponding back-end (BE) slice.

In embodiments, the controller 142 can generate a priority score for each BE slice using the IO statistics and SLO information corresponding to the BE slice's associated TDEV track. The controller 142 can provide weights to each BE slice based on the priority of their corresponding IO statistics and SLO information. For instance, the controller 142 can compute a combined score for each BE slice (e.g., Slices 1-N) based on the weighted SLO and IO statistics of all its constituent TDEC tracks. This aggregation process ensures that the priority score reflects the slice's overall importance and activity level.

In embodiments, the controller 142 can provide weights based on each SLO's corresponding service level, with higher service levels (e.g., Platinum, Diamond, and Gold SLs) receiving higher weights than lower service levels (e.g., Silver and Bronze SLs). The controller 142 can also provide weights on certain IO statistics based on their relative importance. For example, write frequency and read frequency can have higher weights than IO size and burst frequency. Accordingly, the controller 142 can generate a final priority score for each BE slice by combining the scores of all corresponding tracks of each BE slice (e.g., using a weighted average or sum).

In embodiments, the controller 142 can maintain a BE slice database 406 in global memory (e.g., the global memory 128 of FIG. 1). The BE slice database 406 can include SLO slice objects (e.g., Slices 1-N), which contains the priority score of a BE slice for rebuild based on Service Level Objective (SLO) and IO statistics. Each SLO object can include n bits (e.g., 2 bits) representing the priority score. This score is determined by Front End (FE) SLO categories and IO statistics, as described above. The controller 142 can structure the BE slice database 406 as an array of SLO Slice groups (e.g., TDATs 1-N). Each SLO group can include a designated number of SLO slices. The controller 142 can establish each SLO group as a grouping of related SLO objects (e.g., those with similar priority scores). In addition, the controller 142 can provide each SLO group with metadata, including details of each slice object's related priority score. Further, the metadata can include information corresponding to the usage of the slices in each SLO group, minimizing unnecessary table read/write operations for unused groups. By grouping SLO Slice objects, the controller 142 can potentially reduce the number of database queries and improve overall performance when accessing or updating priority scores.

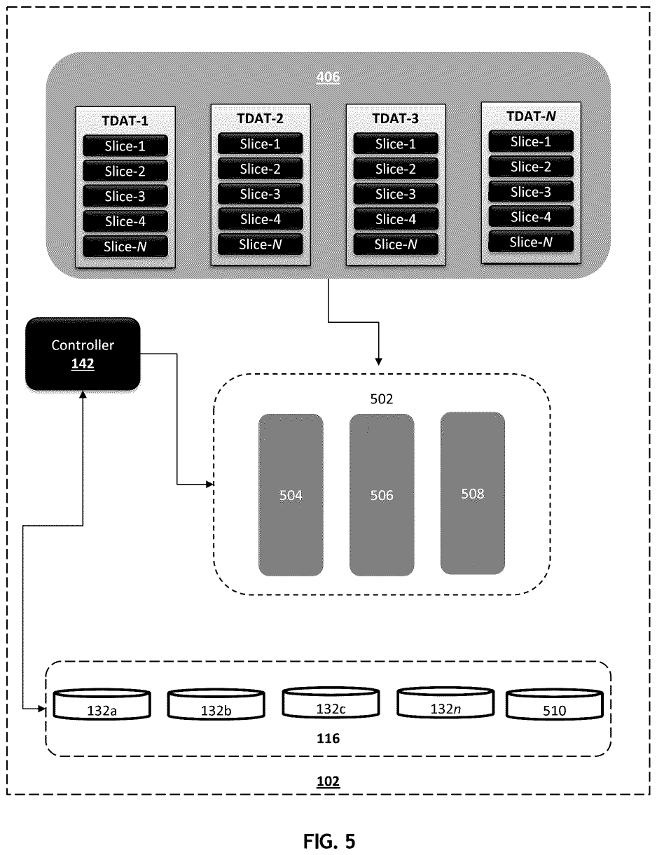

Regarding FIG. 5, a storage array 102 can include a controller 142 that monitors the health of persistent storage 116. Specifically, the controller 142 can detect events requiring a rebuild of a persistent storage device (e.g., one or more of the devices 132a-n). In response to detecting the event, the controller 142 can rebuild a device using a spare drive 510. Events requiring a rebuild can include disk failures, media errors, firmware issues, environmental stress, overutilization, data redundancy compromisation, performance degradation, etc. Upon detecting any of these events, the controller 142 can initiate a rebuild process, starting with identifying each back-end slice associated with the affected persistent storage device.

In embodiments, the controller 142 can identify each BE slice associated with the persistent storage device (e.g., one of the devices 132a-n) corresponding to a detected event. In response to identifying each BE slice, the controller 142 can map the BE slices to physical slices corresponding to the storage device involved in the event. Specifically, the controller 142 can analyze the RAID configuration of the storage devices 132a-n to determine how data is distributed across the multiple drives 132a-n. Each BE slice can correspond to byte chunks (e.g., 128K) on the physical drives 132a-n. For example, each BE slice can include metadata identifying its corresponding device number, a logical representation of a physical device used for addressing and management purposes.

Upon identifying each BE slice associated with the physical device involved in the event, the controller 142 can rebuild the drive by using the database 406, prioritizing BE slices of the physical device based on their respective priority scores.

For example, the controller 142 can establish priority job queues 502 including, e.g., queues 504-508. Each queue 504-506 can be associated with a corresponding rebuild priority level. In embodiments, the controller 142 can structure each queue 504-508 to accommodate rebuild jobs based on their priority scores. For instance, the controller 142 can establish n queues, where n represents different priority levels. (e.g., Diamond, Silver, Bronze, etc.). Further, the controller 142 can initialize the queues 504-508, preparing them to receive and organize rebuild jobs based on their priority scores. Accordingly, the controller 142 can map each queue to a range of priority scores, with higher priority queues corresponding to higher priority score ranges.

Further, the controller 142 can dynamically manage the queues 504-508 by adding, removing, or reprioritizing rebuild jobs based on BE slice priority scores. Accordingly, the controller 142 can use the database 406 to place a BE slice in a rebuild queue (e.g., one of the queues 504-508) based on its respective priority score. Further, the controller 142 can rebuild the storage drive corresponding to the event in an order determined by each BE slices placement and position in the queues 504-508.

The following text includes details of a method(s) or a flow diagram(s) per embodiments of this disclosure. For simplicity of explanation, each method is depicted and described as a set of alterable operations. Additionally, one or more operations can be performed in parallel, concurrently, or in a different sequence. Further, not all the illustrated operations are required to implement each method described by this disclosure.

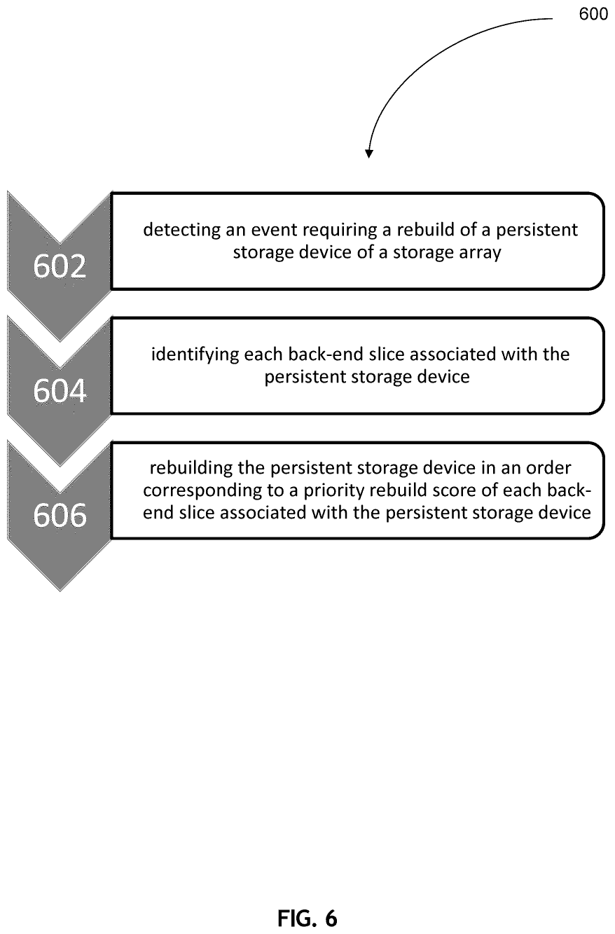

Regarding FIG. 6, a method 600 relates to prioritizing rebuilding a storage device. In embodiments, the controller 142 of FIG. 1 can perform all or a subset of operations corresponding to the method 600.

For example, the method 600, at 602, can include detecting an event requiring a rebuild of a persistent storage device of a storage array. Additionally, at 604, the method 600 can include identifying each back-end slice associated with the persistent storage device. Further, the method 600, at 606, can include rebuilding the persistent storage device in an order corresponding to a priority rebuild score of each back-end slice associated with the persistent storage device.

Further, each operation can include any combination of techniques implemented by the embodiments described herein. Additionally, one or more of the storage array's components 108 can implement one or more of the operations of each method described above.

Using the teachings disclosed herein, a skilled artisan can implement the above-described systems and methods in digital electronic circuitry, computer hardware, firmware, or software. The implementation can be a computer program product. Additionally, the implementation can include a machine-readable storage device for execution by or to control the operation of a data processing apparatus. The implementation can, for example, be a programmable processor, a computer, or multiple computers.

A computer program can be in any programming language, including compiled or interpreted languages. The computer program can have any deployed form, including a stand-alone program, subroutine, element, or other units suitable for a computing environment. One or more computers can execute a deployed computer program.

One or more programmable processors can perform the method steps by executing a computer program to perform the concepts described herein by operating on input data and generating output. An apparatus can also perform the steps of the method. The apparatus can be a special-purpose logic circuitry. For example, the circuitry is an FPGA (field-programmable gate array) or an ASIC (application-specific integrated circuit). Subroutines and software agents can refer to portions of the computer program, the processor, the special circuitry, software, or hardware that implements that functionality.

Processors suitable for executing a computer program include, by way of example, both general and special purpose microprocessors and any one or more processors of any digital computer. A processor can receive instructions and data from a read-only memory, a random-access memory, or both. Thus, for example, a computer's essential elements are a processor for executing instructions and one or more memory devices for storing instructions and data. Additionally, a computer can receive data from or transfer data to one or more mass storage device(s) for storing data (e.g., magnetic, magneto-optical disks, solid-state drives (SSDs, or optical disks).

Data transmission and instructions can also occur over a communications network. Information carriers that embody computer program instructions and data include all nonvolatile memory forms, including semiconductor memory devices. The information carriers can, for example, be EPROM, EEPROM, flash memory devices, magnetic disks, internal hard disks, removable disks, magneto-optical disks, CD-ROM, or DVD-ROM disks. In addition, the processor and the memory can be supplemented by or incorporated into special-purpose logic circuitry.

A computer with a display device enabling user interaction can implement the above-described techniques, such as a display, keyboard, mouse, or any other input/output peripheral. The display device can, for example, be a cathode ray tube (CRT) or a liquid crystal display (LCD) monitor. The user can provide input to the computer (e.g., interact with a user interface element). In addition, other kinds of devices can enable user interaction. Other devices can, for example, be feedback provided to the user in any form of sensory feedback (e.g., visual feedback, auditory feedback, or tactile feedback). For example, input from the user can be in any form, including acoustic, speech, or tactile input.

A distributed computing system with a back-end component can also implement the above-described techniques. The back-end component can, for example, be a data server, a middleware component, or an application server. Further, a distributing computing system with a front-end component can implement the above-described techniques. The front-end component can, for example, be a client computer with a graphical user interface, a web browser through which a user can interact with an example implementation, or other graphical user interfaces for a transmitting device. Finally, the system's components can interconnect using any form or medium of digital data communication (e.g., a communication network). Examples of communication network(s) include a local area network (LAN), a wide area network (WAN), the Internet, a wired network(s), or a wireless network(s).

The system can include a client(s) and server(s). The client and server (e.g., a remote server) can interact through a communication network. For example, a client-and-server relationship can arise when computer programs run on the respective computers and have a client-server relationship. Further, the system can include a storage array(s) that delivers distributed storage services to the client(s) or server(s).

Packet-based network(s) can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), 802.11 network(s), 802.16 network(s), general packet radio service (GPRS) network, HiperLAN), or other packet-based networks. Circuit-based network(s) can include, for example, a public switched telephone network (PSTN), a private branch exchange (PBX), a wireless network, or other circuit-based networks. Finally, wireless network(s) can include RAN, Bluetooth, code-division multiple access (CDMA) networks, time division multiple access (TDMA) networks, and global systems for mobile communications (GSM) networks.

The transmitting device can include, for example, a computer, a computer with a browser device, a telephone, an IP phone, a mobile device (e.g., cellular phone, personal digital assistant (PDA) device, laptop computer, electronic mail device), or other communication devices. The browser device includes, for example, a computer (e.g., desktop computer, laptop computer) with a World Wide Web browser (e.g., Microsoft® Internet Explorer® and Mozilla®). The mobile computing device includes, for example, a Blackberry®.

Comprise, include, or plural forms of each are open-ended, include the listed parts, and contain additional unlisted elements. Unless explicitly disclaimed, the term ‘or’ is open-ended and includes one or more of the listed parts, items, elements, and combinations thereof.

What is claimed is:

1. A method comprising:
detecting an event requiring a rebuild of a persistent storage device of a storage array;
identifying each back-end slice associated with the persistent storage device; and
rebuilding the persistent storage device in an order corresponding to a priority rebuild score of each back-end slice associated with the persistent storage device.

2. The method of claim 1, further comprising:
identifying each front-end logical track corresponding to each back-end slice associated with the persistent storage device.

3. The method of claim 2, further comprising:
monitoring one or more input/output (IO) workloads received by the storage array; and
collecting IO statistics corresponding to each IO operation targeting each front-end logical track.

4. The method of claim 3, further comprising:
determining a service level objective (SLO) corresponding to each front-end logical;

5. The method of claim 4, further comprising:
calculating a priority score for each back-end slice based on the IO statistics and the SLO of each front-end logical track corresponding to each back-end slice.

6. The method of claim 5, further comprising:
generating an SLO slice object to represent each back-end slice, wherein each SLO slice object includes n-bits representing its corresponding priority rebuild score; and
grouping SLO slice objects in an SLO database stored in a shared memory of the storage array.

7. The method of claim 7, further comprising:
updating the priority score for each back-end slice during one or more Local Synchronous Write Destage (LSWD) processes.

8. The method of claim 7, further comprising:
establishing at least one rebuild job queue, including a corresponding rebuild priority level.

9. The method of claim 8, further comprising:
queuing each back-end slice requiring a rebuild in the at least one rebuild job queue based on the priority rebuild score of each back-end slice and the rebuild priority level of the at least one rebuild job queue.

10. The method of claim 9, further comprising:
rebuilding the persistent storage device in an order defined by a position of each back-end slice in the at least one rebuild job queue.

11. An apparatus with a memory and processor, the apparatus configured to:
detect an event requiring a rebuild of a persistent storage device of a storage array;
identify each back-end slice associated with the persistent storage device;
and rebuild the persistent storage device in an order corresponding to a priority rebuild score of each back-end slice associated with the persistent storage device.

12. The apparatus of claim 11, further configured to:
identify each front-end logical track corresponding to each back-end slice associated with the persistent storage device.

13. The apparatus of claim 12, further configured to:
monitor one or more input/output (IO) workloads received by the storage array; and
collect IO statistics corresponding to each IO operation targeting each front-end logical track.

14. The apparatus of claim 13, further configured to:
determine a service level objective (SLO) corresponding to each front-end logical;

15. The apparatus of claim 14, further configured to:
calculate a priority score for each back-end slice based on the IO statistics and the SLO of each front-end logical track corresponding to each back-end slice.

16. The apparatus of claim 15, further configured to:
generate an SLO slice object to represent each back-end slice, wherein each SLO slice object includes n-bits representing its corresponding priority rebuild score; and
group SLO slice objects in an SLO database stored in a shared memory of the storage array.

17. The apparatus of claim 17, further configured to:
update the priority score for each back-end slice during one or more Local Synchronous Write Destage (LSWD) processes.

18. The apparatus of claim 17, further configured to:
establish at least one rebuild job queue, including a corresponding rebuild priority level.

19. The apparatus of claim 18, further configured to:
queue each back-end slice requiring a rebuild in the at least one rebuild job queue based on the priority rebuild score of each back-end slice and the rebuild priority level of the at least one rebuild job queue.

20. The apparatus of claim 19, further configured to:
rebuild the persistent storage device in an order defined by a position of each back-end slice in the at least one rebuild job queue.
